(19) United States
(12) Patent Application Publication
(10) Pub. No.: US 2013/0085242 A1
(43) Pub. Date: Apr. 4, 2013

(54) PREPARATION OF POLYMERS BY CONTROLLED FREE-RADICAL POLYMERIZATION

(71) Applicants: Pascal HESSE, Mannheim (DE); Sven FLEISCHMANN, Ludwigshafen (DE); Florian BECKER, Mannheim (DE); Klaus MUEHLBACH, Gruenstadt (DE); Klaus-Dieter HUNGENBERG, Birkenau (DE); Markus BRYM, Limburgerhof (DE); Matthias KLEINER, Mannheim (DE)

(72) Inventors: Pascal HESSE, Mannheim (DE); Sven FLEISCHMANN, Ludwigshafen (DE); Florian BECKER, Mannheim (DE); Klaus MUEHLBACH, Gruenstadt (DE); Klaus-Dieter HUNGENBERG, Birkenau (DE); Markus BRYM, Limburgerhof (DE); Matthias KLEINER, Mannheim (DE)

(73) Assignee: BASF SE, Ludwigshafen (DE)

(21) Appl. No.: 13/597,703

(22) Filed: Aug. 29, 2012

Related U.S. Application Data
(60) Provisional application No. 61/528,773, filed on Aug. 30, 2011.

(51) Int. Cl. C08F 4/54

(52) U.S. Cl. CPC C08F 4/54
USPC 526/108; 526/90; 526/329.7

(57) ABSTRACT

Process for preparing polymers by controlled free-radical polymerization, wherein the polymerization of one or more free-radically polymerizable monomers of the general formula (I)

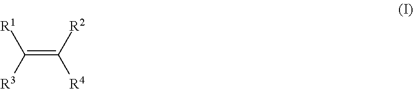

where R¹, R², R³ are each H, C₁-C₄-alkyl, R⁴ is C(═O)0R⁵, C(═O)NHR¹⁵, C(═O)NR⁵R⁶, OC(═O)CH₃, C(═O)OH, CN, aryl, hetaryl, C(═O)OR⁵OH, C(═O)OR⁵Si(OR⁵)₃, halogen, NHC(O)H, P(═O)(OR⁷)₂,

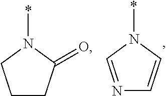

R⁵ is C₁-C₂₀-alkyl, R¹⁵ is C₁-C₂₀-alkyl, R⁶ is C₁-C₂₀-alkyl, R⁷ is H, C₁-C₂₀-alkyl, in the presence of a. one or more catalysts comprising Cu in the form of Cu(0), Cu(I), Cu(II) or mixtures thereof, b. one or more initiators selected from the group consisting of organic halides or pseudohalides, c. one or more ligands, d. optionally one or more solvents, e. optionally one or more inorganic halide salts, and comprises the steps i) addition of the catalyst a., ii) optionally addition of monomers of the general formula (I), iii) optionally addition of solvent d., iv) addition of ligand c., v) addition of initiator b., vi) addition of monomers of the general formula (I), vii) optionally addition of inorganic halide salts e., with the proviso that the addition of at least part of the monomers of the general formula (I) is carried out immediately before or shortly after the last of the steps i), iv) and v).

The present invention relates to a process for preparing polymers by controlled free-radical polymerization. Furthermore, the invention relates to polymers prepared by this process and also the use of these polymers.

Further embodiments of the present invention may be found in the claims, the description and the examples. It goes without saying that the features mentioned above and those still to be explained below of the subject matter of the invention can be used not only in the combination specifically indicated in each case but also in other combinations without going beyond the scope of the invention. Preference or particular preference is also given, in particular, to those embodiments of the present invention in which all features of the subject matter of the invention have the preferred or particularly preferred meanings.

WO 96/130421 A1 describes ATRP (atom transfer radical polymerization) processes as a special case of “living” or “controlled” free-radical polymerization. ATRP processes are based on redox reactions between transition metals (for example Cu(I)/Cu(II)) and are used for living free-radical polymerization of monomers such as styrene or (meth)acrylates. Organic halogen compounds are used as initiators and transition metal complexes are used as catalysts for the polymerization reaction. According to WO 96/130421 A1, polymers having a controlled and narrow molar mass distribution are formed in this way.

WO 97/18247 A1 likewise describes ATRP processes with participation of a proportion of a reduced or oxidized transition metal which deactives free radicals. Further variations of the process comprise polymerization in homogeneous systems or in the presence of solubilized initiator/catalyst systems.

WO 98/40415 A1 and WO 00/56795 A1 describe further embodiments of ATRP processes in which, for example, specific ligands, counterions or metals are selected for the transition metal complexes.

WO 02/38618 A2 relates to a process for preparing polymer compositions by means of a continuous process in which ethylenically unsaturated monomers are polymerized by means of inititiators which have a transferable atom group and catalysts which comprise transition metals in the presence of ligands which can form a coordination compound with the catalysts.

WO 2008/019100 A2 describes SET-LRP (single electron transfer—living radical polymerization) processes using Cu(0), Cu₂Te, CuSe, Cu₂S and/or Cu₂O catalysts. Furthermore, the polymerization reactions are carried out using initiators and a component comprising solvent and optionally nitrogen-comprising ligands. Here, the interaction of this component with the monomer leads to disproportionation of Cu(I) halides to form Cu(II) halides and metallic Cu(0).

In Chemical Reviews, 109, 5069-5119 (2009), Rosen et al. give a review of SET-LRP processes.

EP 0 850 957 A1 describes processes for the controlled free-radical polymerization of (meth)acrylic monomers and/or further monomers, in which at least one of the monomers is polymerized at a temperature which can be up to 0° C. in the presence of an initiator system. The initiator system comprises a compound which generates free radicals and a catalyst comprising metal complexes with ligands.

WO 2009/155303 A2 describes processes for the controlled free-radical polymerization of monomers, in particular using methods of living free-radical polymerization. Here, a mixture comprising at least one monomer, a solvent, a compound which is able to coordinate metals and an initiator is used. This mixture is passed over the surface of a solid-state catalyst which is located in a vessel outside the reaction vessel.

SET-LRP processes make it possible to carry out free-radical polymerization reactions in a controlled manner and with an increased reaction rate compared to conventional ATRP processes (cf. Rosen et al.). One of the subobjects of the present invention was to make it possible to use this effect on an industrial scale and to optimize the reaction rate further.

A particular challenge in the SET-LRP process is given by a high heat of reaction evolved in a short period of time, which can be influenced only incompletely by means of temperature control. A subobject of the present invention was therefore to provide a process which makes it possible to control the rapid heat evolution in the reaction. SET-LRP processes carried out on an industrial scale, in particular, using a relatively large amount to be reacted represent a challenge in respect of the rapid evolution of heat. A subobject of the invention was therefore to provide a process which allows reactions to be carried out on an industrial scale while adhering to safety requirements.

A further object of the present invention was therefore to provide SET-LRP processes for preparing polymers, which processes allow control of the molar mass distribution of the polymers to be maintained even at elevated polymerization temperatures. A further object of the present invention was to provide SET-LRP processes for preparing polymers which allow the polymers to be made available in a very short time.

In general, SET-LRP processes were frequently carried out on a laboratory scale, and there is therefore a need to provide processes which allow adaptation of the reaction conditions and starting materials to industrial scale production. In particular, improvements in the catalyst, the reactor type and the way of carrying out the reaction are objects of the invention.

In the preparation of block copolymers, particularly block copolymers of acrylates and methacrylates, the method described in the prior art using Cu salts slows the reaction rate and increases the introduction of copper into the resulting polymer. Another subobject of the present invention was therefore to provide processes which do not have these disadvantages in block copolymer formation.

These and other objects are, as can be seen from the disclosure content of the present invention, achieved by the various embodiments of the process of the invention for preparing polymers by controlled free-radical polymerization, wherein the polymerization of one or more free-radically polymerizable monomers of the general formula (I)

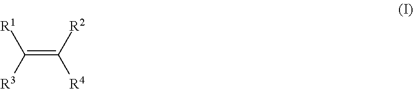

where
R¹ is H, C₁-C₄-alkyl, preferably H, C₁-C₂-alkyl, particularly preferably H,
R² is H, C₁-C₄-alkyl, preferably H, C₁-C₂-alkyl, particularly preferably H, CH₃,
R³ is H, C₁-C₄-alkyl, preferably H, C₁-C₂-alkyl, particularly preferably H,
R⁴ is C(═O)OR⁵, C(═O)NHR¹⁵, C(═O)NR⁵R⁶, OC(═O)CH₃, C(═O)OH, CN, aryl, hetaryl, C(═O)OR⁵OH, C(═O)OR⁵Si(OR⁵)₃, halogen, preferably Cl, NHC(O)H, P(═O)(OR⁷)₂,

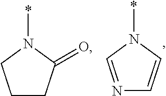

R⁵ is C₁-C₂₀-alkyl, preferably C₁-C₁₂-alkyl, in particular ethylhexyl,
R¹⁵ is C₁-C₂₀-alkyl, preferably isopropyl,
R⁶ is C₁-C₂₀-alkyl, preferably C₁-C₁₀-alkyl, particularly preferably C₁-C₅-alkyl, in particular C₁-C₂-alkyl, very particularly preferably C₁-alkyl,
R⁷ is H, C₁-C₂₀-alkyl, preferably C₁-C₁₀-alkyl, particularly preferably C₁-C₃-alkyl, in particular C₂-alkyl,
   where the substituents R⁵, R⁶, R⁷ and R¹⁵ may each be interrupted by one or more heteroatoms in any position, where the number of these heteroatoms is not more than 10, preferably not more than 8, very particularly preferably not more than 5 and in particular not more than 3, and/or may each be substituted in any position, but not more than five times, preferably not more than four times and particularly preferably not more than three times, by NR⁸R⁹, C(═O)NR⁸R⁹, C(═O)R¹⁰, C(═O)OR¹⁰, SO₃R¹⁰, CN, NO₂, C₁-C₂₀-alkyl, C₁-C₂₀-alkoxy, aryl, aryloxy, heterocycles, heteroatoms or halogen, where these may likewise be substituted not more than twice, preferably not more than once, by the abovementioned groups,
R⁸, R⁹, R¹⁰ are identical or different and are each, independently of one another, H, C₁-C₂₀-alkyl, C₂-C₂₀-alkenyl, C₂-C₂₀-alkynyl, C₃-C₁₅-cycloalkyl, aryl,
   is carried out in the presence of
a. one or more catalysts comprising Cu in the form of Cu(0), Cu(I), Cu (II) or mixtures thereof,
b. one or more initiators selected from the group consisting of organic halides and pseudohalides,
c. one or more ligands,
d. optionally one or more solvents,
e. optionally one or more inorganic halide salts,
   and comprises the steps
i) addition of the catalyst a.,
ii) optionally addition of monomers of the general formula (I),
iii) optionally addition of solvent d.,
iv) addition of ligand c.,
v) addition of initiator b.,
vi) addition of monomers of the general formula (I),
vii) optionally addition of inorganic halide salts e.,
   with the proviso that the addition of at least part of the monomers of the general formula (I) is carried out immediately before or shortly after the last of the steps i), iv) and v). Preferably, at least part of the monomers of the general formula (I) is placed in the reaction vessel before the last of the steps i), iv) and v) is carried out. Preference is likewise given to adding at least part of the monomers of the general formula (I) simultaneously with the last of the steps i), iv) and v). Preference is likewise given to adding at least part of the monomers of the general formula (I) within 60 minutes after the last of the steps i), iv) and i, particularly preferably within 30 minutes, very particularly preferably within 10 minutes and in particular within 5 minutes.

Expressions of the type Cₐ-C_{b} denote, for the purposes of the present invention, chemical compounds or substituents having a particular number of carbon atoms. The number of carbon atoms can be selected from the entire range from a to b, including a and b; a is at least 1 and b is always greater than a. Further specification of the chemical compounds or of the substituents is given by expressions of the type Cₐ-C_{b}-V. V is here a class of chemical compounds or class of substituents, for example alkyl compounds or alkyl substituents.

Halogen is fluorine, chlorine, bromine or iodine, preferably chlorine, bromine or iodine, particularly preferably chlorine or bromine.

Pseudohalogens are the groups —CN, —N3, —OCN, —NCO, —CNO, —SCN, —NCS, —SeCN, preferably —CN, —OCN, —NCO, —SCN, —NCS.

In detail, the collective terms indicated for the various substituents have the following meanings:

C₁-C₂₀-Alkyl: straight-chain or branched hydrocarbon radicals having up to 20 carbon atoms, for example C₁-C₁₀-alkyl or C₁₁-C₂₀-alkyl, preferably C₁-C₁₀-alkyl, for example C₁-C₃-alkyl such as methyl, ethyl, propyl, isopropyl, or C₄-C₆-alkyl, n-butyl, sec-butyl, tert-butyl, 1,1-dimethylethyl, pentyl, 2-methylbutyl, 1,1-dimethylpropyl, 1,2-dimethylpropyl, 2,2-dimethylpropyl, 1-ethylpropyl, hexyl, 2-methylpentyl, 3-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 2-ethylbutyl, 1,1,2-trimethylpropyl, 1,2,2-trimethylpropyl, 1-ethyl-1-methylpropyl, 1-ethyl-2-methylpropyl, or C₇-C₁₀-alkyl such as heptyl, octyl, 2-ethylhexyl, 2,4,4-trimethylpentyl, 1,1,3,3-tetramethylbutyl, nonyl or decyl and also the isomers thereof.

C₁-C₂₀-Alkoxy refers to a straight-chain or branched alkyl group which has from 1 to 20 carbon atoms (as mentioned above) and is bound via an oxygen atom (—O—), for example C₁-C₁₀-alkoxy or C₁₁-C₂₀-alkoxy, preferably C₁-C₁₀-alkyloxy, particularly preferably C₁-C₃-alkoxy such as methoxy, ethoxy, propoxy.

C₂-C₂₀-Alkenyl: unsaturated, straight-chain or branched hydrocarbon radicals having from 2 to 20 carbon atoms and a double bond in any position, for example C₂-C₁₀-alkenyl or C₁₁-C₂₀-alkenyl, preferably C₂-C₁₀-alkenyl such as C₂-C₄-alkenyl, e.g. ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, or C₅-C₆-alkenyl such as 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl or 1-ethyl-2-methyl-2-propenyl, and also C₇-C₁₀-alkenyl such as the isomers of heptenyl, octenyl, nonenyl or decenyl.

C₂-C₂₀-Alkynyl: straight-chain or branched hydrocarbon groups having from 2 to 20 carbon atoms and a triple bond in any position, for example C₂-C₁₀-alkynyl or C₁₁-C₂₀-alkynyl, preferably C₂-C₁₀-alkynyl such as C₂-C₄-alkynyl, e.g. ethynyl, 1-propynyl, 2-propynyl, 1-butynyl, 2-butynyl, 3-butynyl, 1-methyl-2-propynyl, or C5-C7-alkynyl such as 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl or 1-ethyl-1-methyl-2-propynyl and also C₇-C₁₀-alkynyl such as the isomers of heptynyl, octynyl, nonynyl, decynyl.

C₃-C₁₅-Cycloalkyl: monocyclic, saturated hydrocarbon groups having from 3 to 15 ring carbons, preferably C₃-C₈-cycloalkyl such as cyclopropyl, cyclobutyl, cyclopentyl, cyclohexyl, cycloheptyl or cyclooctyl and also a saturated or unsaturated cyclic system such as norbornyl or norbornenyl.

Aryl: a monocyclic to tricyclic aromatic ring system comprising from 6 to 14 ring carbons, e.g. phenyl, naphthyl or anthracenyl, preferably a monocyclic to bicyclic, particularly preferably monocyclic, aromatic ring system.

Aryloxy: is a monocyclic to tricyclic aromatic ring system (as mentioned above) which is bound via an oxygen atom (—O—), preferably a monocyclic to bicyclic, particularly preferably monocyclic, aromatic ring system.

Hetaryl: heterocyclic substituents which are formally derived from aryl groups by replacement of one or more methine (—C═) and/or vinylene (—CH═CH—) groups by trivalent or divalent heteroatoms. Preferred heteroatoms are oxygen, nitrogen and/or sulfur. Particular preference is given to nitrogen and/or oxygen.

Heterocycles: five- to twelve-membered, preferably five- to nine-membered, particularly preferably five- to six-membered, ring systems having oxygen, nitrogen and/or sulfur atoms and optionally having a plurality of rings, e.g. furyl, thiophenyl, pyrryl, pyridyl, indolyl, benzoxazolyl, dioxolyl, dioxyl, benzimidazolyl, benzothiazolyl, dimethylpyridyl, methyiquinolyl, dimethylpyrryl, methoxyfuryl, dimethoxypyridyl, difluoropyridyl, methylthiophenyl, isopropylthiophenyl or tert-butylthiophenyl. The heterocycles can be chemically bound in any way, for example via a bond to a carbon atom of the heterocycle or a bond to one of the heteroatoms. Furthermore, in particular, five- or six-membered saturated nitrogen-comprising ring systems which are bound via a ring nitrogen and can also comprise one or two further nitrogen atoms or a further oxygen or sulfur atom.

Heteroatoms are phosphorus, oxygen, nitrogen or sulfur, preferably oxygen, nitrogen or sulfur, whose free valences may optionally bear H or C₁-C₂₀-alkyl.

As monomers of the general formula (I), preference is given to using alkyl(meth)acrylates, substituted (meth)acrylates, N-substituted (meth)acrylamides or N,N-disubstituted (meth)acrylamides in the process of the invention.

The amounts of the components a. to e. and of the monomer of the general formula (I) which are used in the process of the invention can vary over a wide range, depending on the desired properties of the polymers. Preference is given to the proportion of catalyst a. being from 0.0001 to 10% by weight, the proportion of initiator b. being from 0.01 to 10.0% by weight, the proportion of ligand c. being from 0.0001 to 1.0% by weight, the proportion of solvent d. being from 0 to 70% by weight, the proportion of halide salt e. being from 0 to 5.0% by weight and the proportion of monomer of the general formula (I) being from 4 to 99.9898% by weight, in each case based on the total amount of components a. to e. together with monomer of the general formula (I). The total amount of monomer of the general formula (I) and components a. to e. is 100% by weight. Particular preference is given to the proportion of catalyst a. being from 0.001 to 5% by weight, the proportion of initiator b. being from 0.1 to 5% by weight, the proportion of ligand c. being from 0.001 to 0.5% by weight, the proportion of solvent d. being from 0 to 60% by weight, the proportion of halide salt e. being from 0 to 4% by weight. In particular, the proportion of catalyst a. is from 0.002 to 4% by weight, the proportion of initiator b. is from 0.2 to 4% by weight, the proportion of ligand c. is from 0.002 to 0.4% by weight, the proportion of solvent d. is from 0 to 50% by weight, the proportion of halide salt e. is from 0 to 3% by weight.

In an embodiment of the process of the invention, Cu(0) is preferably used as a solid, in particular in the form of a wire, mesh, gauze or powder, in the catalyst a. In a further preferred embodiment, the catalyst a. comprises Cu(0) zeolites. In particular, Cu(II) is used in addition to metallic Cu(0) in the catalyst in the process of the invention. An advantage of the use of Cu(0) and Cu(II) is that the polymerization reaction proceeds in a controlled manner from the beginning.

In a further preferred embodiment, the catalyst a. comprises copper alloys such as brass or bronze.

In a further preferred embodiment of the process of the invention, the catalysts additionally comprise metals selected from the group consisting of Mn, Ni, Pt, Fe, Ru, V.

In the process of the invention, preference is given to using organic chlorides and bromides, particularly preferably 2,2-dichloroacetophenone, substituted sulfonic acid halides, in particular toluenesulfonyl chloride, methyl 2-bromopropionate, methyl 2-chloropropionate, 2-bromopropionitrile and diethyl 2,6-dibromoheptanedionate and also ethyl 2,5-dibromoadipate as initiators b.

As ligands c. in the process of the invention, preference is given to using those which are able to form complexes with one or more components of the catalyst, with particular preference being given to selecting ligands c. from the group consisting of organic nitrogen compounds, particularly preferably organic polydentate amines, in particular hexamethylenetris(2-aminoethyl)amine, tris(2-aminoethyl)amine, 2,2-bipyridine and polyimine. It is of course also possible to use mixtures of the ligands c.

In a preferred embodiment of the process of the invention, use is made of one or more solvents d., for example alcohols or polyols, preferably dimethyl sulfoxide, methyl ethyl ketone, ethyl acetate, methanol, ethanol, propanol, isobutanol, n-butanol, tert-butanol, glycol, glycerol, ethylene carbonate, propylene carbonate, acetone, lactates, water and mixtures of these solvents, with the water content of the solvent preferably being from 0 to 10% by weight, particularly preferably from 0 to 7% by weight, in particular from 0 to 5% by weight, in each case based on the total amount of solvent. Particular preference is also given to using mixtures of protic and aprotic solvents as solvent.

In a preferred embodiment of the process of the invention, one or more halide salts e., preferably NaCl, NaBr, CaCl₂, also CuCl₂, CuBr₂, are used. Particular preference is given here to NaCl or NaBr. The use of NaCl or NaBr allows block copolymers of acrylates and methacrylates to be prepared advantageously.

In the process of the invention, the addition of monomers vi) is carried out continuously or discontinuously. The monomers of the general formula (I) are added all at once or in a plurality of partial amounts in step vi).

In an embodiment of the process of the invention, the controlled free-radical polymerization is carried out in a semibatch process. Semibatch processes differ from batch processes for free-radical polymerizations by a greater variability of the addition of the starting materials, e.g. by means of feed strategies for monomers in copolymerizations which minimize the change in the polymer composition over the course of the reaction. The free monomer concentrations are generally lower than in a batch process, in particular at the beginning of the reaction, resulting in the hazard potential of the process being minimized in respect of the maximum quantity of heat liberated at any point in time.

This means that at least part of the monomer is slowly introduced by combining the components i. to v. after commencement of the reaction. As a result of suitable feed strategies for monomer and optional initiator, the process can be operated continually with large quantities of heat to be removed (or high reaction rates) while avoiding load peaks.

In another embodiment of the process of the invention, the controlled free-radical polymerization is carried out in a continuous process. To achieve narrow molecular weight distributions in a controlled free-radical polymerization, it is necessary to achieve a narrow residence time distribution in the reactor in continuous polymerization processes. Reactors having plug flow characteristics are therefore useful. These can be not only tube reactors but also belt reactors, cascades of stirred vessels or particular milli reactors. Milli reactors allow good temperature control even in the case of strongly exothermic reactions since they have high heat transfer areas.

In a preferred embodiment of the process of the invention, an acrylate as monomer of the general formula (I) is firstly polymerized to a conversion of >85% using an organic bromide as initiator. Before addition of a methacrylate as further monomer of the general formula (I), for example for introducing a second polymer block, an inorganic chloride, particularly preferably an alkali metal or alkaline earth metal chloride, in particular NaCl, is preferably added. Telechelic polymers having methacrylate groups at the end of the acrylate polymer chain can particularly preferably also be prepared by this process.

In general, the rate of the free-radical polymerization is, as is known to those skilled in the art, dependent on, for example, the temperature, the monomers used, the solvents or the initiator concentration. The rate of the reaction can therefore vary over a wide range. The process of the invention is preferably carried out so that the controlled free-radical polymerization proceeds to a conversion of greater than 80%, preferably greater than 85%, particularly preferably greater than 90%, within a short time, preferably within less than 10 hours, particularly preferably within less than 6 hours, in particular within less than 1 hour.

The polymers obtained in the process of the invention generally have, after a conversion of the monomers of from 80 to 100%, an average molar mass Mn (number average) of from 1000 to 1 000 000 g/mol, preferably from 2000 to 200 000 g/mol, in particular from 3000 to 150 000 g/mol. The average molar masses generally depend, as is known to those skilled in the art, on, inter alia, the concentration of initiator. Here, Mn can be adjusted over a wide range depending on the desired use of the polymer. In the case of sealants, values of from 2000 to 4000 g/mol are sought. In the case of resins and thermoplastics, values of from 100 000 to 150 000 g/mol are usual.

The polymers obtained in the process of the invention generally have, after a conversion of the monomers of from 80 to 100%, an average molar mass Mw (weight average) of from 1100 to 2 000 000 g/mol, preferably from 2200 to 300 000 g/mol, in particular from 3300 to 200 000 g/mol. The polymers obtained in the process of the invention generally have, after a conversion of the monomers of from 80 to 100%, a polydispersity PDI (ratio of weight average to number average molecular weight) of from 1.0 to 2.5, preferably from 1.05 to 1.5, in particular from 1.1 to 1.3.

In a preferred embodiment of the process of the invention, the catalyst a. is added first, followed optionally by the addition of monomers of the general formula (I) and/or solvent d., after which ligand c., initiator b. and optionally inorganic halide salt e. are added. Ligand c. and initiator b. are particularly preferably added simultaneously.

In a further preferred embodiment of the process of the invention, preferably only a little monomer of the general formula (I) is added in step ii). Here, from 5 to 15% by weight of monomer, based on the total amount of components a. to e. and monomer of the general formula (I), is used, preferably from 10 to 15% by weight.

The process of the invention can be carried out in apparatuses of the prior art which are known to those skilled in the art. The polymerization is preferably carried out in a stirred vessel, tube reactor, capillary reactor, belt reactor or another reactor having plug flow characteristics. Continual mixing or optimized mixing-in of components such as ligand and initiator preferably takes place in the apparatuses and can be ensured by means of the mixing apparatuses known to those skilled in the art.

The reaction mixture is frequently corrosive toward the apparatuses used and preference is therefore given to using selected steel alloys such as X1CrNiMoCuN20-18-6 (1.4547), particularly preferably NiCr21Mo14W (2.4602), as materials for the apparatuses. Preference is likewise given to materials such as glass, titanium (3.0735) and chemical enamels.

In a preferred embodiment, catalyst of the component a. is present in all places in which the polymerization reaction is to take place. In the case of reactions on an industrial scale, the Cu(0) comprised in the catalyst is at least partly, preferably mostly, present in powder form: the particle size of the Cu(0) powder is preferably significantly smaller or equal to 45 μm and the proportion of particles larger than 45 μm is preferably not more than 2% by weight. Copper wire, copper gauzes, copper meshes or copper wool have the advantage that the polymer can easily be separated from the catalyst after the reaction. Particular preference is given to using combinations of copper wire, copper gauzes, copper meshes or copper wool with copper powder as constituents of the catalyst a.

In a further preferred embodiment of the process of the invention, purification of the polymers formed by reducing the residual content of copper or copper ions by means of filtration, precipitation, ion exchangers or electrochemical processes is additionally carried out after step vii).

The process of the invention can be carried out at temperatures which vary over a wide range. The choice of temperature depends, for example, on the desired properties of the polymers formed. The process of the invention can also advantageously be used at relatively high temperatures. In general, the process of the invention is carried out at temperatures of from −70 to 180° C., preferably from 0 to 150° C., particularly preferably from 20 to 120° C., in particular from 30 to 120° C.

In a preferred embodiment, the polymerization is carried out partially adiabatically, which has a positive effect on the energy consumption since the heat of reaction is utilized for heating.

In terms of the rate of the reaction and controlling the molecular weight, it is advantageous to start the polymerization at low temperatures, i.e. for example in the range from 20° C. to 50° C., preferably in the range from 30 to 40° C., in order not to generate an additional cooling requirement. The control of the molecular weights which leads to a narrow molecular weight distribution is maintained over the entire temperature range (e.g. from 30 to 90° C.).

The process of the invention can be carried out at pressures which vary over a wide range. For example, the polymerization can be carried out at slightly subatmospheric pressure or else at elevated pressures. The pressure is preferably from 1 to 50 bar, in particular from 1 to 5 bar. The pressure conditions generally also depend on temperature and composition of the system.

The invention further provides polymers which can be obtained by means of the embodiments of the process of the invention. These polymers preferably have average molecular weights Mn and Mw and polydispersities (Mw/Mn) in the abovementioned ranges.

The polymers of the invention are preferably homopolymers, random copolymers, block copolymers, gradient copolymers, graft copolymers, star copolymers or telechelic polymers. Particular preference is given to acrylate-methacrylate diblock copolymers and acrylate-methacrylate multiblock copolymers, particularly preferably acrylate-methacrylate triblock copolymers and block copolymers of acrylates and methacrylates, preferably pBA-b-pMMA or triblock copolymers of pMMA-b-pBA-b-pMMA.

The invention further provides for the use of polymers prepared according to the invention or polymers of the invention as telechelic polymers for sealants, adhesives, polymeric additives or reactive components (e.g. silane-functionalized). When they are used as sealants or adhesives, use is made of, for example, a well-defined OH telechelic polymer as polyol component for the reaction with isocyanates.

The use according to the invention of polymers preferably occurs as triblock copolymers in TPE (thermoplastic elastomer) applications, as impact modifier for styrene-acrylonitrile copolymers or polybutylene terephthalate or as plasticizer/impact modifier for PVC.

Furthermore, the use according to the invention of polymers preferably occurs as dispersants, usually in the form of block copolymers.

The present invention provides processes which allow free-radical polymerization reactions to be carried out even at elevated polymerization temperatures while maintaining control over the molar mass distribution of the polymers. These processes provide polymers within a very short time.

The invention is illustrated by the examples, without the examples restricting the subject matter of the invention.

### EXAMPLES

### Example 1

### Continuous Reaction in a Tube Reactor (Capillary Reactor)

Monomer: methyl acrylate

Solvent: dimethyl sulfoxide

Initiator: methyl 2-bromopropionate

Ligand: hexamethylenetris(2-aminoethyl)amine (Me₆TREN)

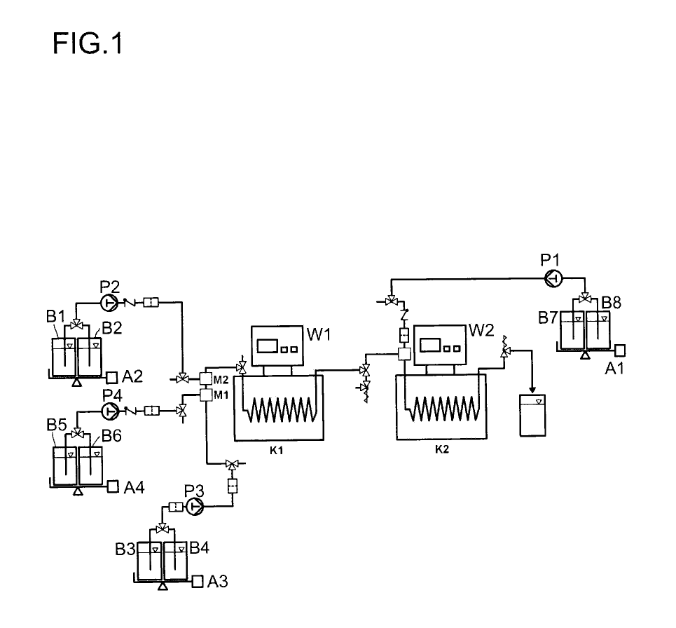

A number of experiments for the continuous mode of operation in a tube reactor were carried out. The experimental set-up is shown schematically in FIG. 1.

FIG. 1 shows:

The experimental set-up of the capillary reactor shown in FIG. 1.

The reactor comprised two capillaries (K1, K2) which each had a length of 10 m (4 mm internal diameter) and through each of which a copper wire having a diameter of 1.6 mm and a length of 10 m had been drawn and which were maintained at temperature by means of the thermostats W1 and W2. Monomers were continuously metered in from a reservoir (B3) via an HPLC pump (P3) and the solvent from (B5) via an HPLC pump (P4) and mixed in a static mixer (M1). The initiator/ligand feed was metered in from reservoir (B1) by means of the HPLC pump (P2) and subsequently mixed with the monomer/solvent feed using a further static mixer (M2). The flows through the pumps P1 to P4 were regulated via the balances A1 to A4. The vessels B2, B4, B6 and B8 make it possible to switch over to solvent for cleaning the reactors. When required, monomer or initiator/ligand can be introduced from the reservoir B7 at a point between the reactors (K1) and (K2) by means of the pump P1.

Here, monomer is effectively introduced immediately before or shortly after the addition of ligand or initiator.

At a residence time (corresponds to the reaction time) of about 38 min and a bath temperature of the thermostats (W1) and (W2) of 70° C., a monomer conversion of above 90% was obtained (molar ratio of monomer to initiator to ligand of 100:1:0.1; solvent content: 73% by weight).

A significant acceleration of the reaction could be achieved in a continuous mode of operation according to the semibatch experiments. The continuous mode of operation offered good control of the reaction because of the large heat exchange area of the tube reactor.

The experimental molecular weight Mn was about 38% higher than the theoretical molecular weight at a polydispersity (Mw/Mn) of 1.36. The molecular weight distribution was broadened as a result of the residence time profile of the tube reactor.

### Example 2

### Semibatch Process

Experimental Set-Up:

Reaction calorimeter METTLER Toledo RC1 with ReactiR 4000, software IC Control 4.0, IC-IR 4.0.

2 m of Cu wire having a diameter of 1 mm were wound around a baffle and introduced via a flange into the reactor. The contact region with the Cu wire increases with increasing fill level, which leads to a comparable Cu exchange area per volume of solution during the course of the monomer addition.

The samples taken at regular intervals from the reactor were analyzed as follows:

1) The solids content was determined by means of a Mettler Toledo HR73 IR dryer. The monomer conversion can be calculated therefrom using the formulation parameters.

2) The molecular weight distribution of the polymer was determined by means of a GPC unit (gel permeation chromatography; Agilent Technologies). This comprised four columns from MZ-Analytik from Mainz. The columns have the dimensions 300×8 mm and are filled with crosslinked divinylbenzene-styrene polymer having a particle size of 5 μm. The porosities are 100, 1000, 10 000 and 100 000 Angstrom. Tetrahydrofuran at 35° C. was used as eluent. Calibration was carried out against narrow-distribution polystyrene standards from PSS (type Ready Kal.) having a peak molecular weight Mp of 2 180 000, 1 000 000, 659 000, 246 000, 128 000, 67 500, 32 500, 18 100, 9130, 3420, 1620 and 374 g/mol. Mn, Mw and PDI were determined from the measured molecular weight distributions.

The number average molecular weight to be expected theoretically, Mn(theor), is calculated from the assumption of equal distribution of all reacted monomer molecules over the chains, with each initiator molecule starting a chain in the case of monofunctional initiators such as methyl 2-bromopropionate (MBP).

The formula used is:

Mₙ(theor)=mₘₒₙₒₘₑᵣ·Mᵢₙᵢₜᵢₐₜₒᵣ·Xₘₒₙₒₘₑᵣ/mᵢₙᵢₜᵢₐₜₒᵣ (1)
mₘₒₙₒₘₑᵣ: total mass of the initially charged monomer and the monomer which has run in up to the time of sampling
mᵢₙᵢₜᵢₐₜₒᵣ: mass of the initiator (initially charged)
Xₘₒₙₒₘₑᵣ: fractional conversion of monomer into polymer (only the initially charged monomer and the monomer which has run in up to the time of sampling is considered again)
Mᵢₙᵢₜᵢₐₜₒᵣ: molar mass of the initiator (167 g·mol⁻¹ in the case of MBP)

Description of the Experiment:

| | | | | |
|---|---|---|---|---|
| Initial charge: | 13.11 | g | of copper wire | |
| | 563.15 | g | of dimethyl sulfoxide (DMSO) | 46.929% |
| Addition: | 0.75 | g | of Me₆TREN | 0.062% |
| | 1.69 | g | of methyl 2-bromopropionate | 0.141% |
| | 40.00 | g | of dimethyl sulfoxide (DMSO) | 3.330% |
| Feed stream 1: | 594.41 | g | of methyl acrylate | 49.535% |

Procedure:

The initial charge was introduced and made inert 3 times with 8 bar of nitrogen. The reactor was heated to 70° C. The copper wire with holder was subsequently installed, the Me₆TREN and methyl 2-bromopropionate were added via a lock and the latter was rinsed with DMSO. Immediately afterwards, the feed stream 1 was started and metered in over a period of 240 minutes. After the end of the introduction of the feed stream, an after-polymerization was carried out for 10 hours. During the metered addition, samples were taken and stabilized with 0.01 g of hydroquinone. The mixture was then cooled and drained.

The course of the reaction shown in Table 1 was obtained:

TABLE 1

| t/min | Conversion/% | Mₙ/(g/mol) | Mₙ^{theor}/(g/mol) | PDI |
|---|---|---|---|---|
| 0 | 0.0 | | | |
| 45 | 5.3 | 5033 | 581 | 1.94 |
| 90 | 9.0 | 5652 | 1989 | 1.76 |
| 172 | 6.3 | 5312 | 2661 | 1.85 |
| 200 | 5.9 | 5741 | 2894 | 1.80 |
| 240 | 5.4 | 5781 | 3178 | 1.82 |
| 300 | 9.1 | 10446 | 5360 | 1.33 |
| 420 | 56.4 | 54301 | 33119 | 1.26 |
| 480 | 72.1 | 65085 | 42369 | 1.30 |
| 540 | 78.1 | 70006 | 45902 | 1.31 |
| 1090 | 87.4 | 88225 | 51357 | 1.11 |

Alternative procedures sometimes resulted in a significant slowing of the polymerization.

A premixed initial charge of ligand and initiator prepared before the actual reaction (i.e. significantly before addition of the monomer) gave slowed polymerization reactions. The greater the time between premixing of ligand and initiator and the addition of the monomer, the more slowly did the polymerization reaction subsequently occur. Presumably, premixing of ligand and initiator leads to activation of the initiator, i.e. short-lived free initiator radicals are presumably formed and quickly terminate in the absence of the monomer. In the subsequent addition of the monomer, these initiators are then presumably no longer available for a reaction and the polymerization reaction slows significantly or hardly any reaction occurs.

In the case of premixing of ligand and initiator before the actual reaction, it was likewise found that the molecular weight control deteriorates since the experimental number average molecular weights are significantly above the theoretically calculated molecular weights. This is probably attributable to the fact that fewer free initiator radicals start chain growth as a result of premature bimolecular termination reactions.

The observations in respect of slowing of the reaction and molecular weight control for the various procedures were less strongly pronounced at a reaction temperature of 70° C. than at 50° C.

### Example 3

a. Batch Process Reaction Calorimeter

Initial charge:

| | | | |
|---|---|---|---|
| 13.11 | g | of copper wire | |
| 563.15 | g | of dimethyl sulfoxide (DMSO) | 46.929% |

Addition:

| | | | |
|---|---|---|---|
| 0.75 | g | of Me₆TREN | 0.062% |
| 1.69 | g | of methyl 2-bromopropionate | 0.141% |
| 40.00 | g | of dimethyl sulfoxide (DMSO) | 3.333% |
| 594.41 | g | of methyl acrylate | 49.535% |

Procedure:

The initial charge was introduced and made inert 3 times with 8 bar of nitrogen. The reactor was heated to 70° C. The copper wire with holder was subsequently installed, the methyl acrylate was added, Me₆TREN and methyl 2-bromopropionate were added directly afterwards via a lock and the latter was rinsed with DMSO. Samples were taken during the reaction and stabilized with 0.01 g of hydroquinone. The mixture was then cooled and drained. The results are summarized in Table 2.

TABLE 2

| t/min | Conversion/% | Mₙ/(g/mol) | Mₙ^{theo}/(g/mol) | PDI |
|---|---|---|---|---|
| 0 | 0.0 | | | |
| 15 | 40.3 | 32112 | 23683 | 1.25 |
| 45 | 70.7 | 49891 | 41504 | 1.18 |
| 138 | 91.2 | 59818 | 53539 | 1.14 |
| 190 | 93.5 | 61257 | 54902 | 1.18 |
| 260 | 95.8 | 67978 | 56241 | 1.18 |
| 320 | 97.0 | 69533 | 56964 | 1.14 |
| 410 | 97.9 | 70221 | 57498 | 1.15 |
| 500 | 100.0 | 68237 | 58738 | 1.25 |

b. Batch Process in the Laboratory

A reaction apparatus comprising a round-bottom flask, reflux condenser, internal thermometer and gas inlet for nitrogen was briefly flushed with protective gas. The copper catalyst was wound as wire having a length of 2 m around the blade stirrer of the apparatus or else added as copper powder (300 mg). 1072.8 g (8.37 mol) of butyl acrylate, 250 ml of methanol and 750 ml of methyl ethyl ketone and also 30.1 g (83.7 mmol) of diethyl dibromoadipate and 1.93 mg (8.37 mmol) of Me₆-TREN were added in succession. The mixture was then heated by means of a heating bath which was maintained at 60° C. Within 5 minutes, the internal temperature rose to reflux temperature (70° C.). The heating bath was removed. To monitor the degree of conversion, the solids content was determined. About 45 minutes after heating, the temperature dropped back to 58° C. and the degree of conversion was 91%. The average molar mass was Mₙ=13 700 g/mol, and the PDI M_{w}/Mₙ was 1.17.

General procedure for the SET-LRP in the laboratory experiment for the further examples:

In the laboratory, the polymerizations by means of SET-LRP were carried out basically as follows:

The glass apparatus comprised a reflux condenser, gas inlet for nitrogen, stirrer (blade stirrer or magnetic stirrer), internal thermometer. The Cu wire was wound around the blade stirrer or around the magnetic stirrer. In some cases, Cu powder or Cu zeolites were used as solid. The apparatus was flushed with nitrogen before the reaction. The flask was charged in succession with monomer, followed immediately by solvent, initiator and ligand. The apparatus was then heated to the desired external temperature, usually 60° C. The commencement of the reaction was indicated by an increase in the internal temperature and the reaction solution becoming green. After a very high degree of conversion, which can be determined via the solids content determined by means of an IR dryer from Sartorius, had been reached, the reaction was stopped by removal of the heating bath and removal of the Cu catalyst. Depending on the use, degrees of conversion of 80-100% were typically sought. The product was finally worked up by taking off residual monomer and solvent by means of a rotary evaporator. Characterization of the polymer was carried out by means of GPC under the above-described conditions. The product was additionally analyzed by 1H-NMR using CDCl₃ as solvent on a 500 MHz spectrometer from Bruker.

### Example 4

### Polymerization of Butyl Acrylate

Results of the experiments are summarized in Table 3:

TABLE 3

| | | | Mn (theor) | Mn (exp) | | Conversion |
|---|---|---|---|---|---|---|
| No. | X | Solv | [g/mol] | [g/mol] | Mw/Mn | [%] |
| 1 | 25 | MeOH | 3800 | 3200 | 1.19 | 95 |
| 2 | 500 | DMSO | 48000 | 59800 | 1.25 | 75 |
| 3 | 200 | — | 23400 | 20000 | 1.15 | 78 |
| 4 | 200 | MEK | 25600 | 23000 | 1.25 | 95 |
| 5 | 200 | MEK/ | 25600 | 22100 | 1.29 | 95 |
| | | MeOH | | | | |
| 6 | 200 | MeOH | 25600 | 26200 | 1.14 | 95 |
| 7 | 1500 | MeOH | 150000 | 116000 | 1.4 | 81 |
| 8 | 10000 | DMSO | 680000 | 480000 | 1.4 | 79 |

Solv: solvent,
MEK: methyl ethyl ketone,
MeOH: methanol,
No. 5: MEK/MeOH = 50/50 (by volume);
External temperature T = 60° C.
[BA]/[I]/[L] = x/1/0.1 (molar ratios)
Conversion: conversion of butyl acrylate monomer
Experiment No. 1 was stopped after 4 hours, and the remaining experiments were stopped after 6 hours.

### Example 5

### Procedure for the Reaction Depending on the Time of Addition of the Monomer

a. Monomer is (Partly) Initially Charged

Initial charge:

| | | | |
|---|---|---|---|
| 13.11 | g | of copper wire | |
| 563.15 | g | of dimethyl sulfoxide (DMSO) | 46.929% |

Addition:

| | | | |
|---|---|---|---|
| 0.75 | g | of Me₆TREN | 0.062% |
| 1.69 | g | of methyl 2-bromopropionate | 0.141% |
| 40.00 | g | of dimethyl sulfoxide (DMSO) | 3.333% |
| 74.30 | g | of methyl acrylate | 6.192% |

Feed stream 1:

| | | | |
|---|---|---|---|
| 520.12 | g | of methyl acrylate | 43.343% |

Procedure:

The initial charge was introduced and made inert 3 times with 8 bar of nitrogen. The reactor was heated to 70° C. The copper wire with holder was subsequently installed, Me₆TREN and methyl 2-bromopropionate were added via a lock and the latter was rinsed with DMSO. 12.5% of the monomer was then metered in over a period of 5 minutes. Feed stream 1 was subsequently metered in over a period of 210 minutes. After the addition of the feed stream was complete, an after-polymerization was carried out for 20 hours. Samples were taken during the metered addition and stabilized with 0.01 g of hydroquinone. The mixture was then cooled and drained. The results are summarized in Table 4.

TABLE 4

| | | Mₙ/ | Mₙ^{theo}/ | |
|---|---|---|---|---|
| t/min | Conv/% | (g/mol) | (g/mol) | PDI |
| 0 | 0.0 | | | |
| 30 | 43.9 | 10060 | 24411 | 6.40 |
| 93 | 42.2 | 15732 | 23509 | 2.80 |
| 162 | 35.1 | 19585 | 19536 | 1.70 |
| 210 | 29.2 | 20288 | 16249 | 1.39 |
| 275 | 31.1 | 22918 | 17319 | 1.28 |
| 300 | 45.2 | 34078 | 25144 | 1.21 |
| 345 | 64.0 | 45591 | 35628 | 1.27 |
| 390 | 76.9 | 51519 | 42786 | 1.27 |
| 450 | 82.8 | 55269 | 46089 | 1.31 |
| 510 | 85.2 | 68523 | 47389 | 1.42 |
| 1140 | 92.5 | 64599 | 51486 | 1.46 |

b. Addition of Monomer Together with Addition of Initiator and Catalyst

cf. Example 2.

| | | | | |
|---|---|---|---|---|
| Initial charge: | 13.11 | g | of copper wire | |
| | 563.15 | g | of dimethyl sulfoxide (DMSO) | 46.929% |
| Addition: | 0.75 | g | of Me6TREN | 0.062% |
| | 1.69 | g | of methyl 2-bromopropionate | 0.141% |
| | 40.00 | g | of dimethyl sulfoxide (DMSO) | 3.330% |
| Feed stream 1: | 594.41 | g | of methyl acrylate | 49.535% |

Procedure:

The initial charge was introduced and made inert 3 times with 8 bar of nitrogen. The reactor was heated to 70° C. The copper wire with holder was subsequently installed, Me₆TREN and methyl 2-bromopropionate were added via a lock and the latter was rinsed with DMSO. 5 minutes afterwards, feed stream 1 was started and metered in over a period of 240 minutes. After the addition of the feed stream was complete, an after-polymerization was carried out for 10 hours. Samples were taken during the metered addition and stabilized with 0.01 g of hydroquinone. The mixture was then cooled and drained. The results are summarized in Table 5.

TABLE 5

| t/min | Conv/% | Mₙ/(g/mol) | Mₙ^{theo}/(g/mol) | PDI |
|---|---|---|---|---|
| 0 | 0.0 | | | |
| 45 | 2.7 | | | |
| 90 | 5.0 | 5028 | 2941 | 2.05 |
| 135 | 6.0 | 4297 | 3542 | 2.03 |
| 195 | 3.2 | 4254 | 1853 | 2.16 |
| 240 | 3.4 | 4046 | 2004 | 2.11 |
| 300 | 4.4 | 4868 | 2597 | 1.80 |
| 360 | 26.3 | 28282 | 15427 | 1.38 |
| 420 | 60.1 | 65105 | 35313 | 1.11 |
| 480 | 73.7 | 85683 | 43305 | 1.13 |
| 857 | 92.6 | 105670 | 54404 | 1.21 |

c. Addition of Monomer After Addition of Initiator and Catalyst

| | | | | |
|---|---|---|---|---|
| Initial charge: | 13.11 | g | of copper wire | |
| | 563.15 | g | of dimethyl sulfoxide (DMSO) | 46.929% |
| Addition: | 0.75 | g | of Me₆TREN | 0.062% |
| | 1.69 | g | of methyl 2-bromopropionate | 0.141% |
| | 40.00 | g | of dimethyl sulfoxide (DMSO) | 3.330% |
| Feed stream 1: | 594.41 | g | of methyl acrylate | 49.535% |

Procedure:

The initial charge was introduced and made inert 3 times with 8 bar of nitrogen. The reactor was heated to 70° C. The copper wire with holder was subsequently installed, Me₆TREN and methyl 2-bromopropionate were added via a lock and the latter was rinsed with DMSO. Before commencement of the addition of feed stream 1, the initial charge was stirred for 60 minutes and the methyl acrylate was subsequently metered in over a period of 240 minutes. After the addition of the feed stream was complete, an after-polymerization was carried out for 10 hours. Samples were taken during the metered addition and stabilized with 0.01 g of hydroquinone. The mixture was then cooled and drained. The results are summarized in Table 6.

TABLE 6

| t/min | Conv/% | Mₙ/(g/mol) | Mₙ^{theo}/(g/mol) | PDI |
|---|---|---|---|---|
| 0 | 0.0 | | | |
| 45 | 0.0 | | | |
| 90 | 0.0 | | | |
| 116 | 0.0 | | | |
| 176 | 0.0 | | | |
| 240 | 0.0 | | | |
| 300 | 0.0 | | | |
| 360 | 0.0 | | | |
| 420 | 7.7 | 15511 | 4542 | 1.67 |
| 480 | 33.6 | 62374 | 19744 | 1.16 |
| 1200 | 89.7 | 154460 | 52709 | 1.36 |

Fitting of equation (1) to the experimental molecular weights in Tables 1 and 4 to 6 enables the effective initiator concentration compared to the ideal reference to be estimated. This is 33% for Example 5c, 51% for Example 5b, 61% for Example 2 and 80% for Example 5a. The GPC was calibrated as described above against narrow-distribution polystyrene standards.

### Example 6

### Reaction Procedure Depending on Temperature Profile

a) Increase in temperature from 30° C. to 70° C.

| | | | | |
|---|---|---|---|---|
| Initial charge: | 13.11 | g | of copper wire | |
| | 563.15 | g | of dimethyl sulfoxide (DMSO) | 48.024% |
| Addition: | 0.75 | g | of Me₆TREN | 0.064% |
| | 1.69 | g | of methyl 2-bromopropionate | 0.144% |
| | 40.00 | g | of dimethyl sulfoxide (DMSO) | 3.411% |
| | 74.30 | g | of methyl acrylate | 6.336% |
| Feed stream 1: | 520.12 | g | of methyl acrylate | 42.021% |

Procedure:

The initial charge was introduced and made inert 3 times with 8 bar of nitrogen. The reactor was heated to 30° C. The copper wire with holder was subsequently installed, 15% of the monomer were metered in over a period of 5 minutes, Me₆TREN and methyl 2-bromopropionate were added via a lock and the latter was rinsed with DMSO. Feed stream 1 was subsequently metered in over a period of 210 minutes and the external temperature was increased to 70° C. over a period of 40 minutes during the metered addition. After the addition of the feed stream was complete, an after-polymerization was carried out for 16 hours. Samples were taken during the metered addition and stabilized with 0.01 g of hydroquinone. The mixture was then cooled and drained. The results are summarized in Table 7.

TABLE 7

| t/min | Conv/% | Mₙ/(g/mol) | Mₙ^{theo}/(g/mol) | PDI |
|---|---|---|---|---|
| 0 | 0.0 | | | |
| 30 | 13.6 | 9206 | 7969 | 3.21 |
| 60 | 28.9 | 8081 | 16949 | 2.31 |
| 105 | 62.2 | 18146 | 36554 | 1.30 |
| 150 | 53.8 | 24748 | 31574 | 1.18 |
| 210 | 39.9 | 27078 | 23420 | 1.18 |
| 270 | 36.8 | 26288 | 21617 | 1.16 |
| 330 | 49.5 | 35079 | 29076 | 1.15 |
| 390 | 69.2 | 47722 | 40649 | 1.18 |
| 450 | 77.8 | 54632 | 45689 | 1.19 |
| 510 | 82.8 | 58236 | 48653 | 1.19 |
| 1123 | 92.9 | 64353 | 54594 | 1.27 |

b) Isothermal at 70° C.

cf. Example 5a.

### Example 7

### Block Copolymers and the Influence of Salt

Acrylate Block on Methacrylate Block

Without Salt

Under a nitrogen atmosphere, 17.9 g (0.14 mmol) of butyl acrylate, followed immediately by 15 ml of methyl ethyl ketone and 5 ml of methanol and also 116 mg (0.7 mmol) of methyl 2-bromopropionate and 32 mg (0.14 mmol) of Me₆TREN were introduced in succession into the reaction apparatus. The reaction solution was heated to 60° C. by means of a heating bath. After a degree of conversion of 91% had been reached, 14.0 g (0.14 mmol) of methyl methacrylate and another 32.1 mg (0.14 mmol) of Me₆TREN were added in the second stage. After a reaction time of 6 hours, the degree of conversion in the second stage was 78%. The product was isolated by precipitation from methanol and the molar masses were determined by means of GPC. Mn=40 000 g/mol, PDI=1.85 (bimodal).

With CuCl₂

Under a nitrogen atmosphere, 17.9 g (0.14 mmol) of butyl acrylate, followed immediately by 15 ml of methyl ethyl ketone and 5 ml of methanol and also 116 mg (0.7 mmol) of methyl 2-bromopropionate and 32 mg (0.14 mmol) of Me₆TREN were introduced in succession into the reaction apparatus. The reaction solution was heated to 60° C. by means of a heating bath. After a degree of conversion of 95% had been reached, 14.0 g (0.14 mmol) of methyl methacrylate and another 32.1 mg (0.14 mmol) of Me₆TREN and 3 mg (0.014 mmol) of copper(II) chloride were added in the second stage. After a reaction time of 6 hours, the degree of conversion in the second stage was 33%. The product was isolated by precipitation from methanol and the molar masses were determined by means of GPC. Mn=26 000 g/mol, Mw/Mn=1.37 (monomodal).

With NaCl

Under a nitrogen atmosphere, 17.9 g (0.14 mmol) of butyl acrylate, followed immediately by 15 ml of methyl ethyl ketone and 5 ml of methanol and also 116 mg (0.7 mmol) of methyl 2-bromopropionate and 32 mg (0.14 mmol) of Me₆TREN were introduced in succession into the reaction apparatus. The reaction solution was heated to 60° C. by means of a heating bath. After a degree of conversion of 93% had been reached, 14.0 g (0.14 mmol) of methyl methacrylate and another 32.1 mg (0.14 mmol) of Me₆TREN and 80 mg (2 mmol) of sodium chloride were added in the second stage. After a reaction time of 6 hours, the degree of conversion in the second stage was 80%. The product was isolated by precipitation from methanol and the molar masses were determined by means of GPC. Mn=42 600 g/mol, Mw/Mn=1.30.

1. A process for preparing polymers by controlled free-radical polymerization, wherein the polymerization of one or more free-radically polymerizable monomers of the general formula (I) 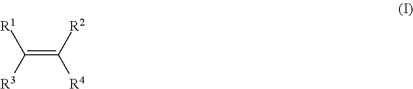
where
R¹ is H, C₁-C₄-alkyl,
R² is H, C₁-C₄-alkyl,
R³ is H, C₁-C₄-alkyl,
R⁴ is C(═O)OR⁵ , C(═O)NHR¹⁵, C(═O)NR⁵R⁶, OC(═O)CH₃, C(═O)OH, CN, aryl, hetaryl, C(═O)OR⁵OH, C(═O)OR⁵Si(OR⁵)₃, halogen, NHC(O)H, P(═O)(OR⁷)₂, 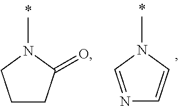
R⁵ is C₁-C₂₀-alkyl,
R¹⁵ is C₁-C₂₀-alkyl,
R⁶ is C₁-C₂₀-alkyl,
R⁷ is H, C₁-C₂₀-alkyl,
where the substituents R⁵, R⁶, R⁷ and R¹⁵ may each be interrupted by one or more heteroatoms in any position, where the number of these heteroatoms is not more than 10, and/or may each be substituted in any position, but not more than five times, by NR⁸R⁹, C(═O)NR⁸R⁹, C(═O)R¹⁰, C(═O)OR¹⁰, SO₃R¹⁰, CN, NO₂, C₁-C₂₀-alkyl, C₁-C₂₀-alkoxy, aryl, aryloxy, heterocycles, heteroatoms or halogen, where these may likewise be substituted not more than twice by the abovementioned groups,
R⁸, R⁹, R¹⁰ are identical or different and are each, independently of one another, H, C₁-C₂₀-alkyl, C₂-C₂₀-alkenyl, C₂-C₂₀-alkynyl, C₃-C₁₅-cycloalkyl, aryl,
is carried out in the presence of
a. one or more catalysts comprising Cu in the form of Cu(0), Cu(I), Cu (II) or mixtures thereof,
b. one or more initiators selected from the group consisting of organic halides and pseudohalides,
c. one or more ligands,
d. optionally one or more solvents,
e. optionally one or more inorganic halide salts,
and comprises the steps
i) addition of the catalyst a.,
ii) optionally addition of monomers of the general formula (I),
iii) optionally addition of solvent d.,
iv) addition of ligand c.,
v) addition of initiator b.,
vi) addition of monomers of the general formula (I),
vii) optionally addition of inorganic halide salts e.,
with the proviso that the addition of at least part of the monomers of the general formula (I) is carried out immediately before or shortly after the last of the steps i), iv) and v).

2. The process according to claim 1, wherein the addition of monomers vi) is carried out continuously or discontinuously.

3. The process according to claim 1 or 2, wherein the monomers vi) are added all at once or in a plurality of partial amounts.

4. The process according to any of claims 1 to 3, wherein the catalyst a. is added first, followed optionally by the addition of monomers of the general formula (I) and/or solvent d., after which ligand c., initiator b. and optionally inorganic halide salt e. are added.

5. The process according to any of claims 1 to 4, wherein ligand c. and initiator b. are added simultaneously.

6. The process according to any of claims 1 to 5, wherein solvent d. is added.

7. The process according to any of claims 1 to 6, wherein purification of the polymer by reducing the residual content of copper or copper ions by means of filtration, precipitation, ion exchangers or electrochemical processes is carried out as a further step after the polymerization.

8. The process according to any of claims 1 to 7, wherein a transition metal-ligand complex is used as catalyst.

9. The process according to any of claims 1 to 8, wherein alkyl(meth)acrylates, substituted (meth)acrylates, N-substituted (meth)acrylamides or N,N-disubstituted (meth)acrylamides are used as monomers.

10. The process according to any of claims 1 to 9, wherein an organic polydentate amine is used as ligand.

11. A polymer which can be obtained by a process according to any of claims 1 to 10.

12. The polymer according to claim 11 which is a homopolymer, random copolymer, block copolymer, gradient copolymer, graft copolymer, star copolymer or telechelic polymer.

13. The use of polymers according to claims 11 and 12 as telechelic polymers for sealants, adhesives, modifiers or reactive components.

14. The use of polymers according to claims 11 and 12 as triblock copolymers in TPE applications, impact modifiers for styrene-acrylonitrile copolymers or polybutylene terephthalate or plasticizer/impact modifier for PVC.

15. The use of polymers according to claims 11 and 12 as dispersants.
